(19) United States
(12) Patent Application Publication
(10) Pub. No.: US 2024/0427982 A1
(43) Pub. Date: Dec. 26, 2024

(54) EVALUATING THE QUALITY OF DOCUMENT CHANGES

(71) Applicant: International Business Machines Corporation, Armonk, NY (US)

(72) Inventors: Qi Li, Beijing (CN); Jonathan D. Dunne, Dungarvan (IE)

(21) Appl. No.: 18/339,275

(22) Filed: Jun. 22, 2023

(51) Int. Cl. G06F 40/166; G06F 40/279; G06Q 10/101

(52) U.S. Cl. CPC G06F 40/166; G06F 40/279; G06Q 10/101

(57) ABSTRACT

A method, computer program product, and computer system are provided for evaluating quality of changes to a collaborative document. Data corresponding to text, metadata, and comments associated with a document is received based on detecting a change to the document. The received data is analyzed based on term frequency, collocations including bigrams and trigrams, and colligates associated with the document. The analyzed data is compared to a corpus of documents from a domain associated with the document. A list of frequencies and collocates associated with the data is generated based on the comparison. An agreement score corresponding to agreement between comments, metadata, and document text is calculated based on the list of frequencies and collocates. The change to the document is caused to be displayed to a user based on the calculated agreement score.

### FIELD

This disclosure relates generally to the field of data processing, and more particularly to document collaboration.

### BACKGROUND

Document and file collaboration are tools or systems set up to help multiple people work together on a single document or file to achieve a single final version. Such tools may include software that may allow teams to work on a single document, such as a word processing document, at the same time from different devices.

### SUMMARY

Embodiments relate to a method, system, and computer program product for evaluating quality of changes to a collaborative document. According to one aspect, a method for evaluating quality of changes to a collaborative document is provided. The method may include receiving data corresponding to text, metadata, and comments associated with a document based on detecting a change to the document. The received data is analyzed based on term frequency, collocations including bigrams and trigrams, and colligates associated with the document. The analyzed data is compared to a corpus of documents from a domain associated with the document. A list of frequencies and collocates associated with the data is generated based on the comparison. An agreement score corresponding to agreement between comments, metadata, and document text is calculated based on the list of frequencies and collocates. The change to the document is caused to be displayed to a user based on the calculated agreement score.

According to another aspect, a computer system for evaluating quality of changes to a collaborative document is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include receiving data corresponding to text, metadata, and comments associated with a document based on detecting a change to the document. The received data is analyzed based on term frequency, collocations including bigrams and trigrams, and colligates associated with the document. The analyzed data is compared to a corpus of documents from a domain associated with the document. A list of frequencies and collocates associated with the data is generated based on the comparison. An agreement score corresponding to agreement between comments, metadata, and document text is calculated based on the list of frequencies and collocates. The change to the document is caused to be displayed to a user based on the calculated agreement score.

According to yet another aspect, a computer program product for evaluating quality of changes to a collaborative document is provided. The computer program product may include one or more computer-readable storage devices and program instructions stored on at least one of the one or more tangible storage devices, the program instructions executable by a processor. The program instructions are executable by a processor for performing a method that may accordingly include receiving data corresponding to text, metadata, and comments associated with a document based on detecting a change to the document. The received data is analyzed based on term frequency, collocations including bigrams and trigrams, and colligates associated with the document. The analyzed data is compared to a corpus of documents from a domain associated with the document. A list of frequencies and collocates associated with the data is generated based on the comparison. An agreement score corresponding to agreement between comments, metadata, and document text is calculated based on the list of frequencies and collocates. The change to the document is caused to be displayed to a user based on the calculated agreement score.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment according to at least one embodiment;

FIG. 2 illustrates a networked computer environment according to at least one embodiment

FIG. 3 is a block diagram of a system for evaluating quality of changes to a collaborative document, according to at least one embodiment; and

FIG. 4 is an operational flowchart illustrating the steps carried out by a program that evaluates quality of changes to a collaborative document, according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

Embodiments relate generally to the field of data processing, and more particularly to document collaboration. The following described exemplary embodiments provide a system, method, and computer program product to, among other things, evaluate quality of changes to a collaborative document. Therefore, some embodiments have the capacity to improve the field of computing by allowing for discourse analysis and Cohen's kappa analysis to infer the level of accordance between changes to technical documents.

As previously described, document and file collaboration are tools or systems set up to help multiple people work together on a single document or file to achieve a single final version. Such tools may include software that may allow teams to work on a single document, such as a word processing document, at the same time from different devices. However, when a group of users reviews collaborative documents in a technical field, the group may need to review whether the documents have factual-based issues. In some instances, junior reviewers may not have the skills or experience to determine whether a document change should be allowed or rejected. Additionally, the reviewers may need to discuss every aspect of the technical document changes, which may be discussed specifically or generally in public channels or technical forums. Reviewers without enough experience may spend a large amount of time and effort to find helpful information in the technical forum on specific document changes. It may be advantageous, therefore, to implement a document change evaluator component for social network systems that may dynamically evaluate code check-ins and other changes to a collaborative document by analyzing a chat history about such document changes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

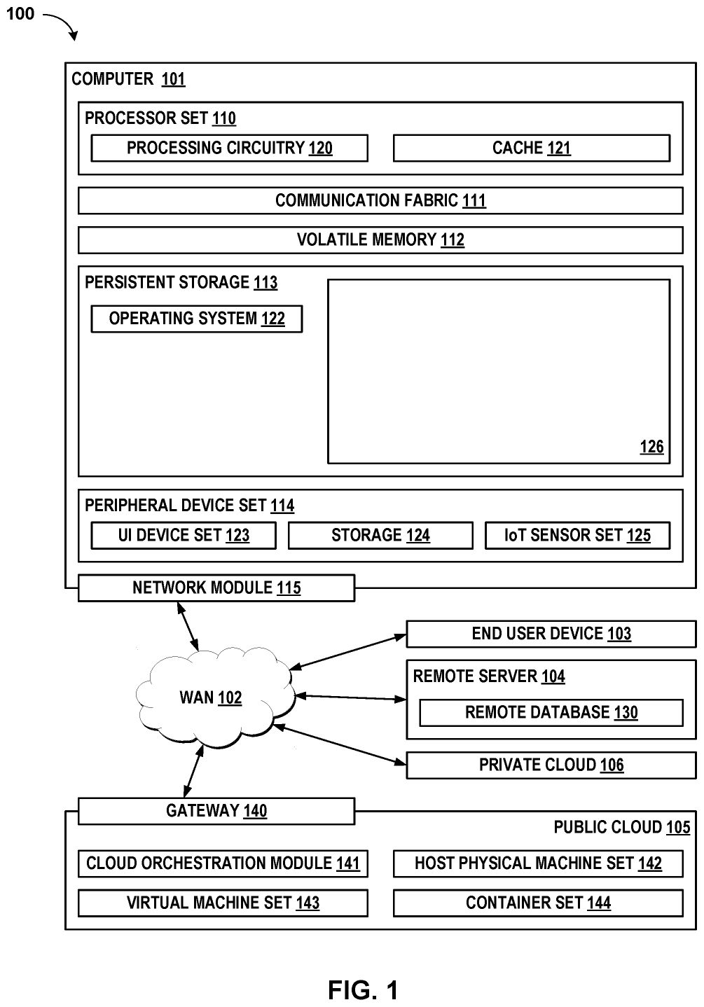

The following described exemplary embodiments provide a system, method and computer program product that evaluates the quality of changes to collaborative documents for accuracy to external source materials. Referring now to FIG. 1, Computing environment 100 contains an example of an environment for the execution of at least some of the computer code involved in performing the inventive methods, such as Document Analysis 126. In addition to Document Analysis 126, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Document Analysis 126, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Document Analysis 126 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in Document Analysis 126 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

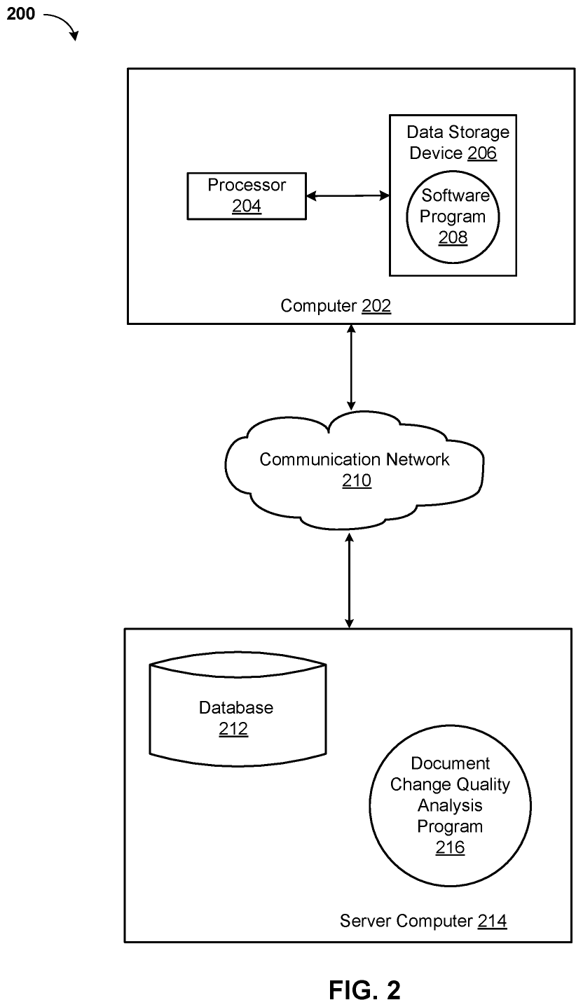

Referring now to FIG. 2, a functional block diagram of a networked computer environment illustrating a document analysis system 200 (hereinafter “system”) for evaluating quality of changes in a collaborative document. It should be appreciated that FIG. 2 provides only an illustration of one implementation and does not imply any limitations with regard to the environments in which different embodiments may be implemented. Many modifications to the depicted environments may be made based on design and implementation requirements.

The system 200 may include a computer 202 and a server computer 214. The computer 202 may communicate with the server computer 214 via a communication network 210 (hereinafter “network”). The computer 202 may include a processor 204 and a software program 208 that is stored on a data storage device 206 and is enabled to interface with a user and communicate with the server computer 214. The computer 202 may be, for example, a mobile device, a telephone, a personal digital assistant, a netbook, a laptop computer, a tablet computer, a desktop computer, or any type of computing devices capable of running a program, accessing a network, and accessing a database.

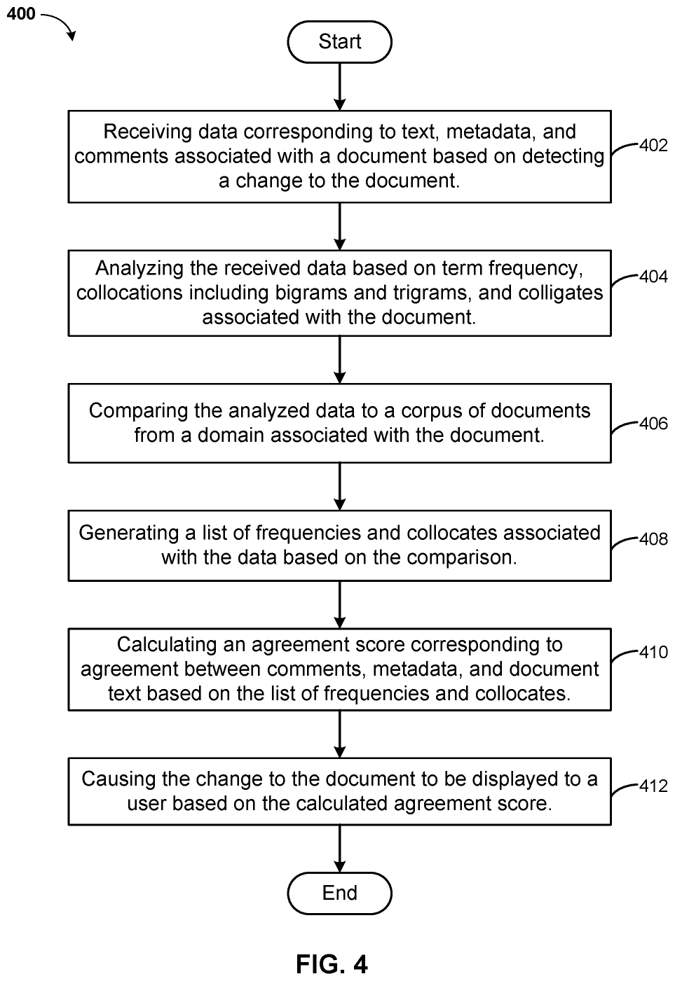

The server computer 214, which may be used for evaluating the quality of changes to collaborative documents for accuracy to external source materials, is enabled to run a Document Change Quality Analysis Program 216 (hereinafter “program”) that may interact with a database 212. The Document Change Quality Analysis Program is explained in more detail below with respect to FIG. 4. In one embodiment, the computer 202 may operate as an input device including a user interface while the program 216 may run primarily on server computer 214. In an alternative embodiment, the program 216 may run primarily on one or more computers 202 while the server computer 214 may be used for processing and storage of data used by the program 216. It should be noted that the program 216 may be a standalone program or may be integrated into a larger document change quality analysis program.

It should be noted, however, that processing for the program 216 may, in some instances be shared amongst the computers 202 and the server computers 214 in any ratio. In another embodiment, the program 216 may operate on more than one computer, server computer, or some combination of computers and server computers, for example, a plurality of computers 202 communicating across the network 210 with a single server computer 214. In another embodiment, for example, the program 216 may operate on a plurality of server computers 214 communicating across the network 210 with a plurality of client computers. Alternatively, the program may operate on a network server communicating across the network with a server and a plurality of client computers.

The network 210 may include wired connections, wireless connections, fiber optic connections, or some combination thereof. In general, the network 210 can be any combination of connections and protocols that will support communications between the computer 202 and the server computer 214. The network 210 may include various types of networks, such as, for example, a local area network (LAN), a wide area network (WAN) such as the Internet, a telecommunication network such as the Public Switched Telephone Network (PSTN), a wireless network, a public switched network, a satellite network, a cellular network (e.g., a fifth generation (5G) network, a long-term evolution (LTE) network, a third generation (3G) network, a code division multiple access (CDMA) network, etc.), a public land mobile network (PLMN), a private network, an ad hoc network, an intranet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of system 200 may perform one or more functions described as being performed by another set of devices of system 200.

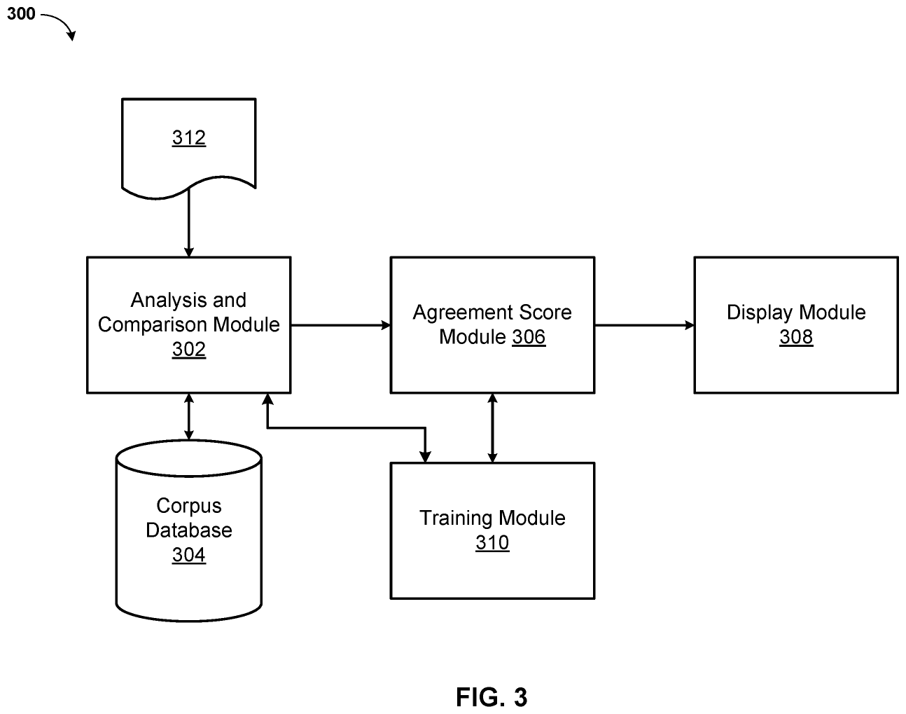

Referring now to FIG. 3. a block diagram of a document change analysis system 300 is depicted according to one or more embodiments. The document change analysis system 300 may be configured to determine whether, at an overall level, there is agreement between document regions and text comments in order to ensure accuracy in the changes made to the collaborative document. The document change analysis system 300 may include, among other things, an analysis and comparison module 302, a corpus database 304, an agreement score module 306, a display module 308, and a training module 310.

The analysis and comparison module 302 may receive input data 312 which may contain, among other things, text associated with a document, metadata about the document, and comments made by one or more users interacting with the document. The analysis and comparison module 302 may obtain term frequency, collocations (bigrams, trigrams) and colligates. The analysis and comparison module 302 may additionally obtain a set of log-likelihood scores based on topic modelling to determine a probabilistic relevancy of changes in the input data 312. The analysis and comparison module 302 may also compare text against text in the corpus database 304 for accordance using Cohen's kappa test. The analysis and comparison module 302 may also analyze chat history in social network systems. From the analysis, the analysis and comparison module 302 may derive a technical document evaluator model that may be used to dynamically evaluate the document changes in the input data 312. The model can be generalized on a per social network platform and temporal basis.

The agreement score module 306 may provide a list of word term frequency and collocates. Next, the agreement score module 306 may use the log-likelihood score of the terms generated by the analysis and comparison module 302 and the Cohen's kappa score of alignment and accordance of text against the text in the corpus database 304. By combining the results of the three numerical scores and normalizing within a range of −1 (i.e., strong disagreement), 0 (i.e., neutral) and 1 (i.e., strong agreement), the agreement score module 306 may use these scores to evaluate accordance within text-based documents. The agreement score module 306 may also time-lock contentious comments, such that document updates with a strong negative accordance may be time-locked and may not appear in a parent document until a threshold level of accordance has been achieved.

The display module 308 may cause the document and changes to be displayed to the user. The display module may include substantially any device capable of displaying information to a user, such as a desktop computer, laptop computer, mobile device, smartphone, tablet computer, augmented reality device, virtual reality device, or the like. The display module 308 may highlight key portions of document text that influence the overall risk score. The highlighting could be rendered, for example, in substantially any markup framework.

The training module 310 may be used to train the document change analysis system 300 by integrating feedback into the model to enhance the accuracy of comparison by the analysis and comparison module 302 to documents in the corpus database 304. The training module 310 may also tune, calibrate, and train the model such that the document change analysis system 300 may be used across a broad range of topic domains. The training module 310 may include substantially any machine learning module, such as a recurrent neural network, a convolutional neural network, or a long-short term memory network.

Referring now to FIG. 4, an operational flowchart illustrating the steps of a method 400 carried out by a program that evaluates quality of changes to a collaborative document is depicted. The method 400 may be described with the aid of the exemplary embodiments of FIGS. 1-3.

At 402, the method 400 may include receiving data corresponding to text, metadata, and comments associated with a document based on detecting a change to the document. The document may be a collaborative document, and, therefore, the change may be made by a user from a plurality of users. In operation, analysis and comparison module 302 (FIG. 3) may receive input data 312 (FIG. 3) that may correspond to a document, changes to the document, metadata about the document, and comments made my users collaboratively working on the document.

At 404, the method 400 may include analyzing the received data based on term frequency, collocations including bigrams and trigrams, and colligates associated with the document. The term frequency, collocations, and colligates may be used determine a domain and an appropriate corpus of documents for determining the quality of the change to the document. In operation, the analysis and comparison module 302 (FIG. 3) may analyze the document for terms contained within the document and changes to the document in order to determine a domain associated with the document.

At 406, the method 400 may include comparing the analyzed data to a corpus of documents from a domain associated with the document. Comparing the analyzed data to the corpus of documents includes calculating a Cohen's kappa score between the change to the document and the documents within the corpus. In operation, the analysis and comparison module 302 (FIG. 3) may identify documents from the corpus database 304 (FIG. 3) based on the analysis of the document. The analysis and comparison module 302 may compare the changes to the documents within the corpus database 304 to determine whether the changes to the document are in accordance with the documents in the corpus.

At 408, the method 400 may include generating a list of frequencies and collocates associated with the data based on the comparison. The list of frequencies may be used as part of the determination as to whether the changes to the document are in accordance with the documents in the corpus. In operation, the analysis and comparison module 302 (FIG. 3) may determine a list of term frequencies associated with document and changes to the document. The analysis and comparison module may compare these frequencies to the documents in the corpus database 304 (FIG. 3).

At 410, the method 400 may include calculating an agreement score corresponding to agreement between comments, metadata, and document text based on the list of frequencies and collocates. The agreement score may be based on the domain, the frequency list, and the Cohen's kappa score. In operation, the agreement score module 306 (FIG. 3) may compile the frequency list, the Cohen's kappa analysis, and the domain to determine whether the changes are in accordance with the documents in the corpus database 304 (FIG. 3). The agreement score module 306 may rank proposed changes in order of their accordance for determining the overall quality of such changes.

At 412, the method 400 may include causing the change to the document to be displayed to a user based on the calculated agreement score. The change to the document or comments associated with the document may be prevented from appearing until a threshold accordance value is reached. The change to the document may be displayed by highlighting portions of the document corresponding to a risk score associated with the change to the document and may be rendered by a markup or other language to be caused to be displayed on a display. In operation, the display module 308 (FIG. 3) may cause the document with changes to be displayed to the user through the software program 208 (FIG. 2) on the computer 202 (FIG. 2). The display module 308 may cause portions of the document to be highlighted. For example, the display module 308 may cause changes supported by the documents in the corpus database 304 (FIG. 3) or having a high agreement score from the agreement score module 306 (FIG. 3) to be highlighted in green, while changes unsupported by the documents in the corpus database 304 or having a low agreement score may be highlighted in red.

It may be appreciated that FIG. 4 provides only an illustration of one implementation and does not imply any limitations with regard to how different embodiments may be implemented. Many modifications to the depicted environments may be made based on design and implementation requirements.

Some embodiments may relate to a system, a method, and/or a computer program product at any possible technical detail level of integration. The computer program product may include a computer-readable non-transitory storage medium (or media) having computer readable program instructions thereon for causing a processor to carry out operations.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer program product may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The descriptions of the various aspects and embodiments have been presented for purposes of illustration but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of evaluating quality of changes to a collaborative document, executable by a processor, comprising:
receiving data corresponding to text, metadata, and comments associated with a document based on detecting a change to the document;
analyzing the received data based on term frequency, collocations including bigrams and trigrams, and colligates associated with the document;
comparing the analyzed data to a corpus of documents from a domain associated with the document;
generating a list of frequencies and collocates associated with the analyzed data based on the comparison;
calculating an agreement score corresponding to agreement between comments, metadata, and document text based on the list of frequencies and collocates, the agreement score combining multiple numerical scores and normalizing a result within a range;
time-locking one or more of the comments such that updates to the document with a negative accordance are subject to the time-lock and do not appear in a parent document until a threshold level of accordance is achieved; and
causing the change to the document to be displayed to a user based on the calculated agreement score.

2. The method of claim 1, wherein causing the change to the document to be displayed comprises highlighting portions of the document corresponding to a risk score associated with the change to the document.

3. The method of claim 2, wherein the highlighted portions are caused to be rendered on a display.

4. The method of claim 1, wherein comparing the analyzed data to the corpus of documents comprises calculating a Cohen's kappa score between the change to the document and the documents within the corpus.

5. The method of claim 1, further comprising preventing the change to the document or comments associated with the document from appearing until a threshold accordance value is reached.

6. The method of claim 1, further comprising training the analysis of the document based on the domain associated with the document.

7. The method of claim 1, wherein the document is caused to be displayed to the user on one or more from among a desktop computer, a laptop computer, a mobile device, a smartphone, a tablet computer, an augmented reality device, and a virtual reality device.

8. A computer system for evaluating quality of changes to a collaborative document, the computer system comprising:
one or more computer-readable storage media configured to store computer program code; and
one or more computer processors configured to access said computer program code and operate as instructed by said computer program code, said computer program code including:
receiving code configured to cause the one or more computer processors to receive data corresponding to text, metadata, and comments associated with a document based on detecting a change to the document;
analyzing code configured to cause the one or more computer processors to analyze the received data based on term frequency, collocations including bigrams and trigrams, and colligates associated with the document;
comparing code configured to cause the one or more computer processors to compare the analyzed data to a corpus of documents from a domain associated with the document;
generating code configured to cause the one or more computer processors to generate a list of frequencies and collocates associated with the data based on the comparison;
calculating code configured to cause the one or more computer processors to calculate an agreement score corresponding to agreement between comments, metadata, and document text based on the list of frequencies and collocates, the agreement score combining multiple numerical scores and normalizing a result within a range;
time-locking one or more of the comments such that updates to the document with a negative accordance are subject to the time-lock and do not appear in a parent document until a threshold level of accordance is achieved; and
causing code configured to cause the one or more computer processors to cause the change to the document to be displayed to a user based on the calculated agreement score.

9. The computer system of claim 8, wherein causing the change to the document to be displayed comprises highlighting portions of the document corresponding to a risk score associated with the change to the document.

10. The computer system of claim 9, wherein the highlighted portions are caused to be rendered on a display.

11. The computer system of claim 8, wherein comparing the analyzed data to the corpus of documents comprises calculating a Cohen's kappa score between the change to the document and the documents within the corpus.

12. The computer system of claim 8, further comprising preventing code stored on the one or more computer-readable storage media, the preventing code configured to cause the one or more computer processors to prevent the change to the document or comments associated with the document from appearing until a threshold accordance value is reached.

13. The computer system of claim 8, further comprising training code stored on the one or more computer-readable storage media, the training code configured to cause the one or more computer processors to train the analysis of the document based on the domain associated with the document.

14. The computer system of claim 8, wherein the document is caused to be displayed to the user on one or more from among a desktop computer, a laptop computer, a mobile device, a smartphone, a tablet computer, an augmented reality device, and a virtual reality device.

15. A computer program product for evaluating quality of changes to a collaborative document, comprising:
one or more computer-readable storage media; and
program instructions stored on at least one of the one or more computer-readable storage media, the program instructions configured to cause one or more computer processors to:
receive data corresponding to text, metadata, and comments associated with a document based on detecting a change to the document;
analyze the received data based on term frequency, collocations including bigrams and trigrams, and colligates associated with the document;
compare the analyzed data to a corpus of documents from a domain associated with the document;
generate a list of frequencies and collocates associated with the data based on the comparison;
calculate an agreement score corresponding to agreement between comments, metadata, and document text based on the list of frequencies and collocates, the agreement score combines multiple numerical scores and normalizes a result within a range;
time-lock one or more of the comments such that updates to the document with a negative accordance are subject to the time-lock and do not appear in a parent document until a threshold level of accordance is achieved; and
cause the change to the document to be displayed to a user based on the calculated agreement score.

16. The computer program product of claim 15, wherein causing the change to the document to be displayed comprises highlighting portions of the document corresponding to a risk score associated with the change to the document.

17. The computer program product of claim 16, wherein the highlighted portions are caused to be rendered on a display.

18. The computer program product of claim 15, wherein comparing the analyzed data to the corpus of documents comprises calculating a Cohen's kappa score between the change to the document and the documents within the corpus.

19. The computer program product of claim 15, wherein the program instructions stored on the at least one of the one or more computer-readable storage media is further configured to cause the one or more computer processors to prevent the change to the document or comments associated with the document from appearing until a threshold accordance value is reached.

20. The computer program product of claim 15, wherein the program instructions stored on the at least one of the one or more computer-readable storage media is further configured to cause the one or more computer processors to train the analysis of the document based on the domain associated with the document.
